(19) United States
(12) Patent Application Publication
(10) Pub. No.: US 2018/0035090 A1
(43) Pub. Date: Feb. 1, 2018

(54) PHOTONIC SIGNAL CONVERTER

(71) Applicant: Sutherland Cook Ellwood, JR., Cheltenham (GB)

(72) Inventor: Sutherland Cook Ellwood, JR., Cheltenham (GB)

(21) Appl. No.: 15/457,967

(22) Filed: Mar. 13, 2017

Related U.S. Application Data
(60) Provisional application No. 62/308,361, filed on Mar. 15, 2016.

(51) Int. Cl. H04N 9/67; H04N 9/76; H04N 9/31

(52) U.S. Cl. CPC H04N 9/67; H04N 9/3179; H04N 9/76

(57) ABSTRACT

Decomposition of components of an integrated photonic-signal “converter” into discrete signal processing stages. A basic logic “state” is separated from a color modulation stage which is separated from an intensity modulation stage. This may be thought of as a telecom signal-processing architecture applied to the problem of visible image photonic-signal modulation. For example, three signal-processing stages and three separate device components and operations are proposed. Although additional signal-influencing operations may be added and are contemplated, conversion from conventional signal to other forms such as polaritons, surface plasmons, and superposition of signal and the like are proposed.

### CROSS REFERENCE TO RELATED APPLICATIONS

This application claims benefit of U.S. Patent Application No. 62/308,361 filed 15 Mar. 2016, and this application is related to U.S. patent application Ser. No. 12/371,461, the contents of which are all hereby expressly incorporated by reference thereto in their entireties for all purposes.

### FIELD OF THE INVENTION

The present invention relates generally to conversion of discrete photonic signals, and more specifically to video and digital image and to data processing devices and networks which generate, transmit, receive, switch, allocate, store, and display such data, as well as non-video and non-pixel data processing in arrays, such as sensing arrays and spatial light modulators, and the application and use of data for same, and even more specifically, but not exclusively, to digital video image displays, whether flat screen, flexible screen, 2D or 3D, or projected images, and non-display data processing by device arrays, and to the spatial forms of organization and locating these processes, including compact devices such as flat screen televisions and consumer mobile devices, as well as the data networks which provide image capture, transmission, allocation, division, organization, storage, delivery, display and projection of pixel signals or data signals or aggregations or collections of same.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the field of image display and projection devices, including liquid crystal displays (LCD), gas plasma display panels (PDP's), organic light-emitting diode (OLED), DMD (digital micro-mirror devices), and cathode ray tube (CRT), among the leading and most successful technologies, artificial limitations exist today which prevent the further development of many performance and value criteria and desirable new display features for devices based on these (or any) core modulation technologies.

A major artificial limitation on the further development of any display or projection modulation technology is the tendency to conceive of any display technology as identical to the modulation technology employed to change the fundamental state of pixel or subpixel “on” (lighted) or “off” (dark). A display technology is generally thought of as identical to the pixel-state modulation technology itself. Thus, in general, improvements of the display technology is conceived of as improving the characteristics of an integrated modulator device, the “light-valve.”

Focus has therefore been on improving such modulator device features as the color transmission efficiency of the modulator materials for each color of whatever color system (typically, red-green-blue or RGB) is employed to realize color in a display; related thermal efficiency of the modulator device for the colors which pass through the modulator; switching speed of the modulator device for the colors which pass through the modulator; power consumption of the integrated color modulator; filtering efficiency of modulators which modulate white light and which must be color-filtered; and spatial compactness of the device, especially in the viewing plane (for minimum fill-factor between subpixels or pixels), but also in the depth of the device for direct-view displays where thinness is desired. Flexibility of the display structure is also desirable for many applications, and there are limitations on options to achieve this when there is an assumption of one integrated modulator device per sub-pixel.

The present disclosure applies those principles to the problem of pixel modulation itself at the basic constituent level.

What is needed is a system and method for re-conceiving the process of capture, distribution, organization, transmission, reception, storage, and presentation to the human visual system or to non-display data array output functionality, in a way that liberates device and system design from compromised functionality of non-optimized operative stages of those processes and instead de-composes the pixel-signal processing and array-signal processing stages into operative stages that permits the optimized function of devices best-suited for each stage, which in practice means designing and operating devices in frequencies for which those devices and processes work most efficiently and then undertaking efficient frequency/wavelength modulation/shifting stages to move back and forth between those “Frequencies of convenience,” with the net effect of further enabling more efficient all-optical signal processing, both local and long-haul.

### BRIEF SUMMARY OF THE INVENTION

Disclosed is a system and method for re-conceiving the process of capture, distribution, organization, transmission, storage, and presentation to the human visual system or to non-display data array output functionality, in a way that liberates device and system design from compromised functionality of non-optimized operative stages of those processes and instead de-composes the photonic-signal processing and array-signal processing stages into operative stages that permits the optimized function of devices best-suited for each stage, which in practice means designing and operating devices in frequencies for which those devices and processes work most efficiently and then undertaking efficient frequency/wavelength modulation/shifting stages to move back and forth between those “Frequencies of convenience,” with the net effect of further enabling more efficient all-optical signal processing, both local and long-haul.

The following summary of the invention is provided to facilitate an understanding of some of technical features related to signal processing, and is not intended to be a full description of the present invention. A full appreciation of the various aspects of the invention can be gained by taking the entire specification, claims, drawings, and abstract as a whole.

Specifically, the proposal is to de-compose the components of a typically integrated pixel-signal “modulator” into discrete signal processing stages. Thus, the basic logic “state” of what is typically accomplished in an integrated pixel modulator is separated from the color modulation stage which is separated from the intensity modulation stage. This may be thought of as a telecom signal-processing architecture applied to the problem of visible image pixel modulation. Typically, three signal-processing stages and three separate device components and operations are proposed, although additional signal-influencing operations may be added and are contemplated, including polarization characteristics, conversion from conventional signal to other forms such as polaritons and surface plasmons, superposition of signal (such as a base pixel on/off state superposed on other signal data), etc. Highly distributed video-signal processing architectures across broadband networks, serving relatively “dumb” display fixtures composed substantially of later stages of passive materials, is a major consequence, as well as compact photonic integrated circuit devices which implement discrete signal processing steps in series, on the same device or devices in intimate contact between separate devices, and in large arrays.

The results of the proposed innovation are 1) a highly distributed video-signal processing architectures across broadband networks that serve relatively “dumb” display fixtures composed substantially of later stages of passive materials consequence and 2) compact photonic integrated circuit devices which implement discrete signal processing steps in series, on the same device or devices in intimate contact between separate devices, and in large arrays.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an imaging architecture that may be used to implement embodiments of the present invention;

FIG. 2 illustrates an embodiment of a photonic converter implementing a version of the imaging architecture of FIG. 1 using a photonic converter as a signal processor;

FIG. 3 illustrates a general structure for a photonic converter of FIG. 2; and

FIG. 4 illustrates a particular embodiment for a photonic converter.

### DETAILED DESCRIPTION OF THE INVENTION

Embodiments of the present invention provide a system and method for re-conceiving the process of capture, distribution, organization, transmission, storage, and presentation to the human visual system or to non-display data array output functionality, in a way that liberates device and system design from compromised functionality of non-optimized operative stages of those processes and instead de-composes the pixel-signal processing and array-signal processing stages into operative stages that permits the optimized function of devices best-suited for each stage, which in practice means designing and operating devices in frequencies for which those devices and processes work most efficiently and then undertaking efficient frequency/wavelength modulation/shifting stages to move back and forth between those “Frequencies of convenience,” with the net effect of further enabling more efficient all-optical signal processing, both local and long-haul. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “functional device” means broadly an energy dissipating structure that receives energy from an energy providing structure. The term functional device encompasses one-way and two-way structures. In some implementations, a functional device may be component or element of a display.

As used herein, the term “display” means, broadly, a structure or method for producing display constituents. The display constituents are a collection of display image constituents produced from processed image constituent signals generated from display image primitive precursors. The image primitive precursors have sometimes in other contexts been referred to as a pixel or sub-pixel. Unfortunately the term “pixel” has developed many different meanings, including outputs from the pixel/subpixels, and the constituents of the display image. Some embodiments of the present invention include an implementation that separates these elements and forms additional intermediate structures and elements, some for independent processing, which could further be confused by referring to all these elements elements/structures as a pixel so the various terms are used herein to unambiguously refer to the specific component/element. A display image primitive precursor emits an image constituent signal which may be received by an intermediate processing system to produce a set of display image primitives from the image constituent signals. The collection of display image primitives producing an image when presented, by direct view through a display or reflected by a projection system, to a human visual system under the intended viewing conditions. A signal in this context means an output of a signal generator that is, or is equivalent to, a display image primitive precursor. Importantly, that as long as processing is desired, these signals are preserved as signals within various signal-preserving propagating channels without transmission into free space where the signal creates an expanding wavefront that combines with other expanding wavefronts from other sources that are also propagating in free space. A signal has no handedness and does not have a mirror image (that is there is not a reversed, upside-down, or flipped signal while images, and image portions, have different mirror images). Additionally, image portions are not directly additive (overlapping one image portion on another is difficult, if at all possible, to predict a result) and it can be very difficult to process image portions. There are many different technologies that may be used as a signal generator, with different technologies offering signals with different characteristics or benefits, and differing disadvantages. Some embodiments of the present invention allow for a hybrid assembly/system that may borrow advantages from a combination of technologies while minimizing disadvantages of any specific technology. Incorporated U.S. patent application Ser. No. 12/371,461, describes systems and methods that are able to advantageously combine such technologies and the term display image primitive precursor thus covers the pixel structures for pixel technologies and the sub-pixel structures for sub-pixel technologies.

As used herein, the term “signal” refers to an output from a signal generator, such as a display image primitive precursor, that conveys information about the status of the signal generator at the time that the signal was generated. In an imaging system, each signal is a part of the display image primitive that, when perceived by a human visual system under intended conditions, produces an image or image portion. In this sense, a signal is a codified message, that is, the sequence of states of the display image primitive precursor in a communication channel that encodes a message. A collection of synchronized signals from a set of display image primitive precursors may define a frame (or a portion of a frame) of an image. Each signal may have a characteristic (color, frequency, amplitude, timing, but not handedness) that may be combined with one or more characteristics from one or more other signals.

As used herein, the term “human visual system” (HVS) refers to biological and psychological processes attendant with perception and visualization of an image from a plurality of discrete display image primitives, either direct view or projected. As such, the HVS implicates the human eye, optic nerve, and human brain in receiving a composite of propagating display image primitives and formulating a concept of an image based on those primitives that are received and processed. The HVS is not precisely the same for everyone, but there are general similarities for significant percentages of the population.

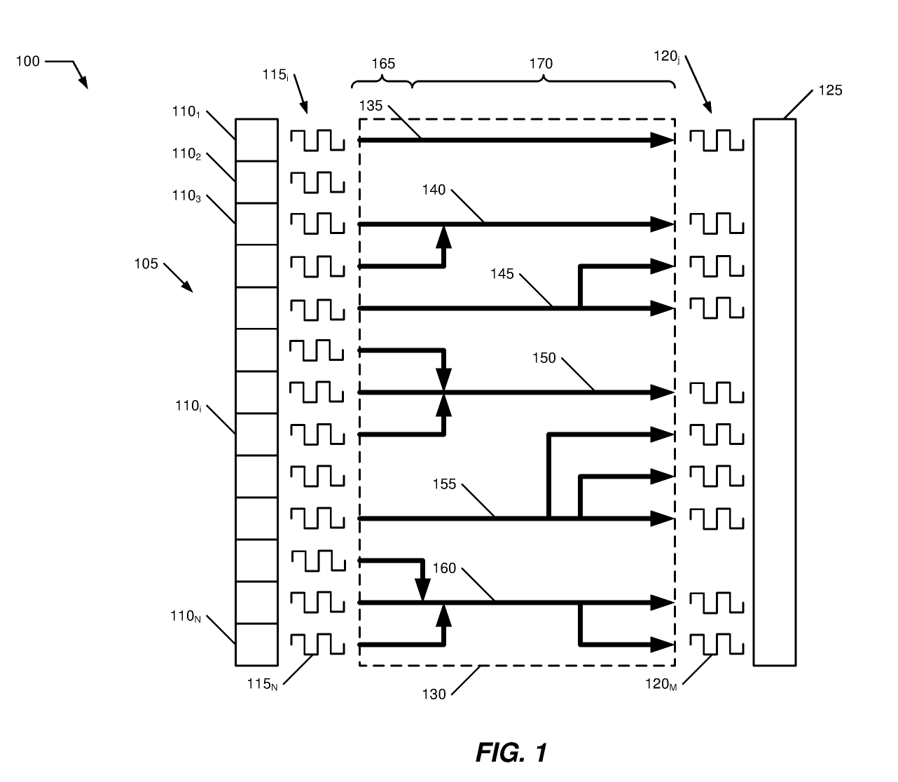

FIG. 1 illustrates an imaging architecture 100 that may be used to implement embodiments of the present invention. Some embodiments of the present invention contemplate that formation of a human perceptible image using a human visual system (HVS)—from a large set of signal generating structures includes architecture 100. Architecture 100 includes: an image engine 105 that includes a plurality of display image primitive precursors (DIPPs) 1101, i=1 to N (N may be any whole number from 1 to tens, to hundreds, to thousands, of DIPPs). Each DIPP 110i is appropriately operated and modulated to generate a plurality of image constituent signals 115ᵢ, i=1 to N (an individual image constituent signal 115ᵢ from each DIPP 110ᵢ). These image constituent signals 115ᵢ are processed to form a plurality of display image primitives (DIPs) 120ⱼ, j=1 to M, M a whole number less than, equal to, or greater than N. An aggregation/collection of DIPs 120ⱼ (such as 1 or more image constituent signals 115ᵢ occupying the same space and cross-sectional area) that will form a display image 125 (or series of display images for animation/motion effects for example) when perceived by the HVS. The HVS reconstructs display image 125 from DIPs 120ⱼ when presented in a suitable format, such as in an array on a display or a projected image on a screen, wall, or other surface. This is familiar phenomenon of the HVS perceiving an image from an array of differently colored or grey-scales shadings of small shapes (such as “dots”) that are sufficiently small in relation to the distance to the viewer (and HVS). A display image primitive precursor 110ᵢ will thus correspond to a structure that is commonly referred to as a pixel when referencing a device producing an image constituent signal from a non-composite color system and will thus correspond to a structure that is commonly referred to as a sub-pixel when referencing a device producing an image constituent signal from a composite color system. Many familiar systems employ composite color systems such as RGB image constituent signals, one image constituent signal from each RGB element (e.g., an LCD cell or the like). Unfortunately, the term pixel and sub-pixel are used in an imaging system to refer to many different concepts—such as a hardware LCD cell (a sub-pixel), the light emitted from the cell (a sub-pixel), and the signal as it is perceived by the HVS (typically such sub-pixels have been blended together and are configured to be imperceptible to the user under a set of conditions intended for viewing). Architecture 100 distinguishes between these various “pixels or sub-pixels” and therefore a different terminology is adopted to refer to these different constituent elements.

Architecture 100 may include a hybrid structure in which image engine 105 includes different technologies for one or more subsets of DIPPs 110. That is, a first subset of DIPPs may use a first color technology, e.g., a composite color technology, to produce a first subset of image constituent signals and a second subset of DIPPS may use a second color technology, different from the first color technology, e.g., a different composite color technology or a non-composite color technology) to produce a second subset of image constituent signals. This allows use of a combination of various technologies to produce a set of display image primitives, and display image 125, that can be superior then when it is produced from any single technology.

Architecture 100 further includes a signal processing matrix 130 that accepts image constituent signals 115ᵢ as an input and produces display image primitives 120ⱼ at an output. There are many possible arrangements of matrix 130 (some embodiments may include single dimensional arrays) depending upon fit and purpose of any particular implementation of an embodiment of the present invention. Generally, matrix 130 includes a plurality of signal channels, for example channel 135-channel 160. There are many different possible arrangements for each channel of matrix 130. Each channel is sufficiently isolated from other channels, such as optical isolation that arises from discrete fiber optic channels, so signals in one channel do not interfere with other signals beyond a crosstalk threshold for the implementation/embodiment. Each channel includes one or more inputs and one or more outputs. Each input receives an image constituent signal 115 from DIPP 110. Each output produces a display image primitive 120. From input to output, each channel directs pure signal information, and that pure signal information at any point in a channel may include an original image constituent signal 115, a disaggregation of a set of one or more processed original image constituent signals, and/or an aggregation of a set of one or more processed original image constituent signals, each “processing” may have included one or more aggregations or disaggregations of one or more signals.

In this context, aggregation refers to a combining signals from an S_{A} number, S_{A}>1, of channels (these aggregated signals themselves may be original image constituent signals, processed signals, or a combination) into a T_{A} number (1≦T_{A}<S_{A}) of channels and disaggregation refers to a division of signals from an S_{D} number, S_{D}≧1, of channels (which themselves may be original image constituent signals, processed signals, or a combination) into a T_{D} number (S_{D}<T_{D}) of channels. S_{A} may exceed N, such as due to an earlier disaggregation without any aggregation and S_{D} may exceed M due a subsequent aggregation. Some embodiments have S_{A}=2, S_{D}=1 and T_{D}=2. However, architecture 100 allows many signals to be aggregated which can produce a sufficiently strong signal that it may be disaggregated into many channels, each of sufficient strength for use in the implementation. Aggregation of signals follows from aggregation (e.g., joining, merging, combining, or the like) of channels or other arrangement of adjacent channels to permit joining, merging, combining or the like of signals propagated by those adjacent channels and disaggregation of signals follows from disaggregation (e.g., splitting, separating, dividing, or the like) of a channel or other channel arrangement to permit splitting, separating, dividing or the like of signals propagated by that channel. In some embodiments, there may be particular structures or element of a channel to aggregate two or more signals in multiple channels (or disaggregate a signal in a channel into multiple signals in multiple channels) while preserving the signal status of the content propagating through matrix 130.

There are a number of representative channels depicted in FIG. 1. Channel 135 illustrates a channel having a single input and a single input. Channel 135 receives a single original image constituent signal 115ₖ and produces a single display image primitive 120ₖ. This is not to say that channel 135 may not perform any processing. For example, the processing may include a transformation of physical characteristics. The physical size dimensions of input of channel 135 is designed to match/complement an active area of its corresponding/associated DIPP 110 that produces image constituent signal 115ₖ. The physical size of the output is not required to match the physical size dimensions of the input—that is, the output may be relatively tapered or expanded, or a circular perimeter input may become a rectilinear perimeter output. Other transformations include repositioning of the signal—while image constituent signal 115₁ may start in a vicinity of image constituent signal 115₂, display image primitive 1201 produced by channel 135 may be positioned next to a display image primitive 120ₓ produced from a previously “remote” image constituent signal 115ₓ. This allows a great flexibility in interleaving signals/primitives separated from the technologies used in their production. This possibility for individual, or collective, physical transformation is an option for each channel of matrix 130.

Channel 140 illustrates a channel having a pair of inputs and a single output (aggregates the pair of inputs). Channel 140 receives two original image constituent signals, signal 115₃ and signal 115₄ for example, and produces a single display image primitive 120₂, for example. Channel 140 allows two amplitudes to be added so that primitive 120₂ has a greater amplitude than either constituent signal. Channel 140 also allows for an improved timing by interleaving/multiplexing constituent signals; each constituent signal may operate at 30 Hz but the resulting primitive may be operated at 60 Hz, for example.

Channel 145 illustrates a channel having a single input and a pair of outputs (disaggregates the input). Channel 140 receives a single original image constituent signal, signal 115₅, for example, and produces a pair of display image primitives—primitive 120₃ and primitive 120₄. Channel 145 allows a single signal to be reproduced, such as split into two parallel channels having many of the characteristics of the disaggregated signal, except perhaps amplitude. When amplitude is not as desired, as noted above, amplitude may be increased by aggregation and then the disaggregation can result in sufficiently strong signals as demonstrated in others of the representative channels depicted in FIG. 1.

Channel 150 illustrates a channel having three inputs and a single output. Channel 150 is included to emphasize that virtually any number of independent inputs may be aggregated into a processed signal in a single channel for production of a single primitive 120₅, for example.

Channel 155 illustrates a channel having a single input and three outputs. Channel 150 is included to emphasize that a single channel (and the signal therein) may be disaggregated into virtually any number of independent, but related, outputs and primitives, respectively. Channel 155 is different from channel 145 in another respect—namely the amplitude of primitives 120 produced from the outputs. In channel 145, each amplitude may be split into equal amplitudes (though some disaggregating structures may allow for variable amplitude split). In channel 155, primitive 120₆ may not equal the amplitude of primitive 120₇ and 120₈ (for example, primitive 120₆ may have an amplitude about twice that of each of primitive 120₇ and primitive 120₈ because all signals are not required to be disaggregated at the same node). The first division may result in one-half the signal producing primitive 120₆ and the resulting one-half signal further divided in half for each of primitive 120₇ and primitive 120₈.

Channel 160 illustrates a channel that includes both aggregation of a trio of inputs and disaggregation into a pair of outputs. Channel 160 is included to emphasize that a single channel may include both aggregation of signals and disaggregation of signal. A channel may thus have multiple regions of aggregations and multiple regions of disaggregation as necessary or desirable.

Matrix 130 is thus a signal processor by virtue of the physical and signal characteristic manipulations of processing stage 170 including aggregations and disaggregations.

In some embodiments, matrix 130 may be produced by a precise weaving process of physical structures defining the channels, such as a Jacquard weaving processes for a set of optical fibers that collectively define many thousands to millions of channels.

Broadly, embodiments of the present invention may include an image generation stage (for example, image engine 105) coupled to a primitive generating system (for example, matrix 130). The image generation stage includes a number N of display image primitive precursors 110. Each of the display image primitive precursors 110ᵢ generate a corresponding image constituent signal 115ᵢ. These image constituent signals 115ᵢ are input into the primitive generating system. The primitive generating system includes an input stage 165 having M number of input channels (M may equal N but is not required to match—in FIG. 1 for example some signals are not input into matrix 130). An input of an input channel receives an image constituent signal 115ₓ from a single display image primitive precursor 110ₓ. In FIG. 1, each input channel has an input and an output, each input channel directing its single original image constituent signal from its input to its output, there being M number of inputs and M number of outputs of input stage 165. The primitive generating system also includes a distribution stage 170 having P number of distribution channels, each distribution channel including an input and an output. Generally M=N and P can vary depending upon the implementation. For some embodiments, P is less than N, for example, P=N/2. In those embodiments, each input of a distribution channel is coupled to a unique pair of outputs from the input channels. For some embodiments, P is greater than N, for example P=N*2. In those embodiments, each output of an input channel is coupled to a unique pair of inputs of the distribution channels. Thus the primitive generating system scales the image constituent signals from the display image primitive precursors—in some cases multiple image constituent signals are combined, as signals, in the distribution channels and other times a single image constituent signal is divided and presented into multiple distribution channels. There are many possible variations of matrix 130, input stage 165, and distribution stage 170.

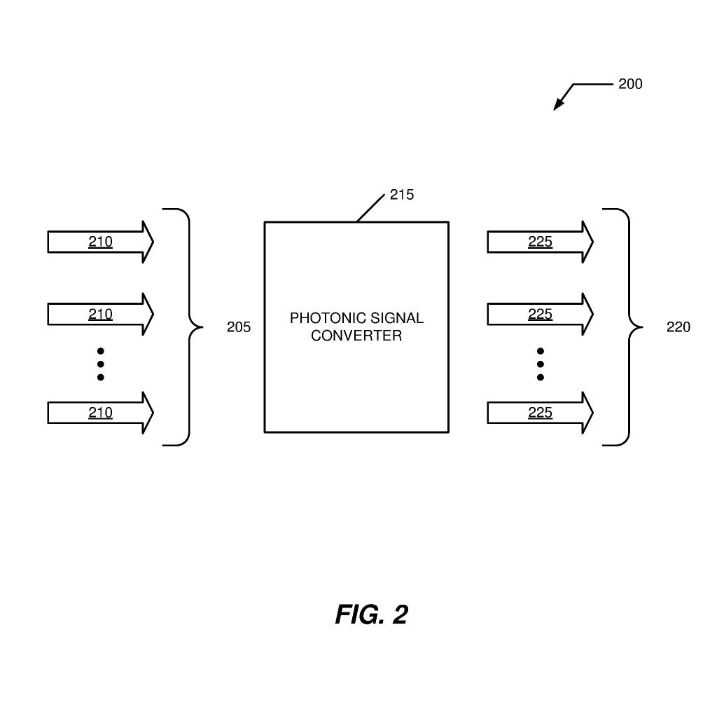

FIG. 2 illustrates an embodiment of an imaging system 200 implementing a version of the imaging architecture of FIG. 1. Systems 200 includes a set 205 of encoded signals, such as a plurality of image constituent signals (at IR/near IR frequencies) that are provided to a photonic signal converter 215 that produces a set 220 of digital image primitives 225, preferably at visible frequencies and more particularly at real-world visible imaging frequencies.

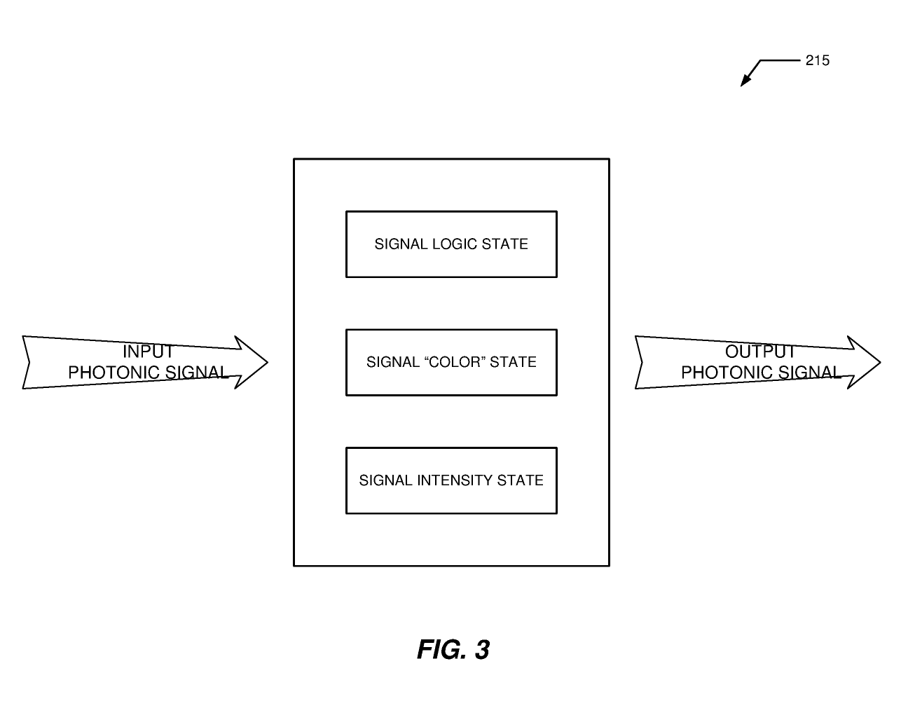

FIG. 3 illustrates a general structure for photonic signal converter 215 of FIG. 2. Converter 215 receives one or more input photonic signals and produces one or more output photonic signals. Converter 215 adjusts various characteristics of the input photonic signal(s), such as signal logic state (e.g., ON/OFF), signal color state (IR to visible), and/or signal intensity state.

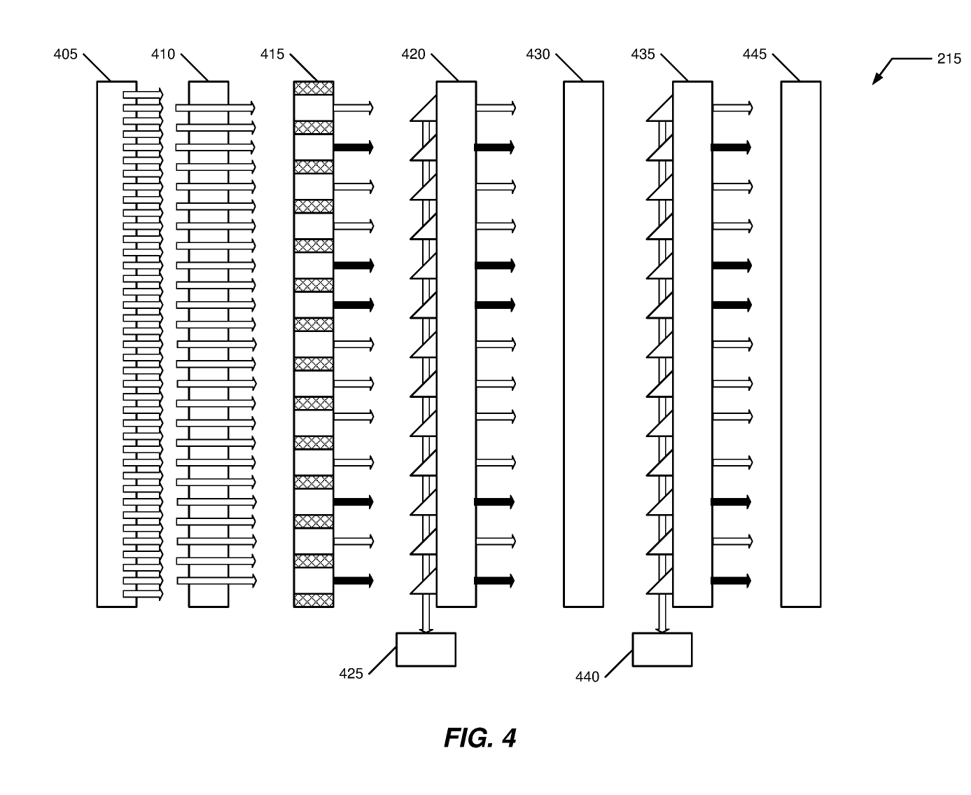

FIG. 4 illustrates a particular embodiment for a photonic converter 400. Converter 405 includes an efficient light source 405. Source 405 may, for example, include an IR and/or near-IR source for optimal modulator performance in subsequent stages (e.g., LED array emitting in IR and/or near-IR). Converter 400 includes an optional bulk optical energy source homogenizer 410. Homogenizer 410 provides a structure to homogenize polarization of light from source 405 when necessary or desirable. Homogenizer 410 may be arranged for active and/or passive homogenization.

Converter 400 next, in an order of light propagation from source 405, includes an encoder 415. Encoder 415 provides logic encoding of light from source 405, that may have been homogenized, to produce encoded signals. Encoder 405 may include hybrid magneto-photonic crystals (MPC), Mach-Zehnder, transmissive valve, and the like. Encoder 415 may include an array or matrix of modulators to set the state of a set of image constituent signals. In this regard, the individual encoder structures may operate equivalent to display image primitive precursors (e.g., pixels and/or sub-pixels, and/or other display optical-energy signal generator.

Converter 400 includes an optional filter 420 such as a polarization filter/analyzer (e.g., photonic crystal dielectric mirror) combined with planar deflection mechanism (e.g., prism array/grating structure(s)).

Converter 400 includes an optional energy recapturer 425 that recaptures energy from source 405 (e.g., IR-near-IR deflected energy) that is deflected by elements of filter 420.

Converter 400 includes an adjuster 430 that modulates/shifts wavelength or frequency of encoded signals produced from encoder 415 (that may have been filtered by filter 420). Adjuster 430 may include phosphors, periodically-poled materials, shocked crystals, and the like.) Adjuster 430 takes IR/near-IR frequencies that are generated/switched and converts them to one or more desired frequencies (e.g., visible frequencies). Adjuster 430 is not required to shift/modulate all input frequencies to the same frequency and may shift/modulate different input frequencies in the IR/near-IR to the same output frequency. Other adjustments are possible.

Converter 400 optionally includes a second filter 435, for example for IR/near-IR energy and may then optionally include a second energy recapturer 440. Filter 435 may include photonic crystal dielectric mirror) combined with planar deflection structure (e.g., prism array/grating structure(s)).

Converter 400 may also include an optional amplifier/gain adjustment 445 for adjusting a one or more parameters (e.g., increasing a signal amplitude of encoded, optionally filtered, and frequency shifted signal). Other, or additional, signal parameters may be adjusted by adjustment 445.

Separation of operations and device types may be assumed to propose significant spatial separation of the stages and devices, enabling many novel physical architectures for displays and projections in which the basic pixel-state signal is originated remotely and distributed to the following stages over a broad-band telecommunications network. This is an important novel and preferred embodiment and feature of the present disclosure, essentially a “direct-display-data” distribution to relatively “dumb” frequency/wavelength modulation and intensity modulation stages (ultimately, using passive materials). Significant intermediate signal processing for image display purposes may be eliminated by fiber-to-display architectures in which the raw light-pulse packet data, containing subpixel-address information as a subset of local device SSID. Routed only to subpixels which are “on”, for video-on-demand and other data-intensive video-streaming applications such as telepresence, total network speeds and local device speeds will increase substantially by shedding unneeded intermediate data and signal processing operations.

As a variation and adjunct to this overall scheme, local (building-level or room-level) specialized video-signal routers/servers may be employed to distribute video signal, employing telecommunications, photonic, and fiber-optic signal processing methods and devices known to the art, including DWDM (dense wave-division multiplexing), to relatively “dumb” display and projection fixtures in a given building or room. Such protocols and specializations can be applied at all scales of direct video-signal distribution, from metro to long-distance.

While such separation of operations and device types enables this important feature and display broadband network signal processing architecture, this does not mean that the operations, processing stages and devices must be physically separated or establish or be part of a highly-distributed video-signal processing network and architecture as proposed above.

In fact, optimized devices which perform the dedicated, de-composed signal-processing stages that ultimately realize a final, viewable subpixel or pixel, may be physically juxtaposed in close intimacy, and as extremely small device features of photonic integrated circuit devices or as physically adjacent or bonded devices with many processing elements fabricated in arrays. Wafer and photonic textile versions are contemplated, with photonic textiles or “optical fabrics” being a structural form particularly compatible with the present disclosure. Such systems are proposed by the inventor of the present disclosure in one or more of the pending application incorporated herein.

A preferred embodiment, at a high level, of the proposed “de-composed” pixel-modulation process where the elements of pixel modulation are performed by discrete, separate stages, device, and operations:

The three primary or typical processing stages for a de-composed, discrete signal processing architecture for generating final, viewable pixel or subpixel signals are: state (pixel-logic); frequency or wavelength modulation; and intensity modulation. It is an important object of some embodiments of the present proposal that this “division of labor” or de-composing of the elements of pixel-modulation is directed so that each stage is optimized, with optimum use of materials and methods at each stage, as opposed to the compromises typically found under and integrated device approach.

Materials that realize the most efficient state-change switching for many modulators, including switching speed and absorption, typically operate at telecom-wavelengths, so that modulating at those wavelengths will be the most efficient for the performance of that component of the total pixel modulation task. Frequency shifting the output from this stage with a subsequent stage provides for a method of optimizing state modulation with the optimal materials and methods, leaving frequency modulation (including for color bandwidth enhancement) to other methods and materials optimized for color output.

In addition, the same materials and methods employed in this two stages, while efficient and low-absorption within an optimal operating range, may be limited in the total amount of optical energy throughput. Thus, an intensity modulation stage, typically employed to amplify the signal, will be employed, using materials and methods optimized for that task.

Intensity modulation has other applications as well. In a pixel-color system in which a subpixel itself may vary intensity, instead of only possessing an on or off state, in addition to the on/off state data of the pixel-logic gate or modulator, a second variable, the intensity variable, is paired with the binary on-off state data. This may be carried as an optical signal with the base on-off signal through to the intensity modulation stage, which is triggered only if the base on-off signal is “on” but which “reads” the intensity level and responds by variably amplifying the signal appropriately. Or, in an opto-electronic device variant, the on-off pixel-logic “gate” state is electronically-addressed to that first device in the series, and the intensity state is electronically-addressed to the intensity modulation device and stage, only if the first stage is addressed “on.”

Among the preferred pixel-logic modulation devices and methods in preferred embodiments of the proposed system are two of the best-in-breed modulation methods found in photonic integrated circuits, photonics and telecommunications signal processing generally. According to one principle of the present disclosure, the pixel-state modulation method is chosen to be optimized for all switching characteristics irrespective of operating frequency. Thus, two of the most preferred methods for use in the present disclosure, and as part of the novel image display and projection system of the present disclosure, are Mach-Zehnder modulators and magneto-optic and magneto-photonic modulators.

An example of a preferred Mach-Zehnder modulator is found in the novel version developed by Green et al at the IBM Watson research center, as first reported in Optics Express, Dec. 10, 2007/Vol. 15, No. 25. A Mach-Zehnder modulator may be defined as a opto-electronic modulator or photonic modulator employing a signal-splitting stage of an optical signal, two “arms” through which an identical signal (split and reduced by at least half in intensity per arm) is passed, and a device functionality to selectively change the index of refraction through movement of charges and holes in at least one of the two arms, such that when the index is changed, the two signals are staggered in relation to each other (net retardation of one of the signal in one of the two branches), and at the point where the two “arms” rejoin, the split signals will interfere and intensity of the recombined signal will be thereby reduced/varied (maximally, to zero). Advantages of M-Z on silicon are compatibility with CMOS fabrication and materials technologies, broad-band operation, and environmental and thermal robustness.

The Green silicon M-Z modulator is a high-speed (10 Gb/s) low-power (5 pJ/bit) and low resistance (49Ω), whose small dimensions achieve a high-carrier density and thus an increase in efficiency by over a factor of two. The rib-waveguides are 550 nm wide and 220 nm high, and the device area is approximately ˜0.12 μm2 including the M-Z arms and the activating P-I-N junction, making the device 100-1000 times smaller than previous M-Z modulators (100 μm total length×10 μm).

Ring-resonator-based modulators have been demonstrated with similar dimensions (the Green M-Z device is only 5× larger), but thus far have shown to be more sensitive to temperature and other environmental and operating conditions and fabrication defects. Such modulators, however, while less-preferred, are also encompassed as optimized pixel-logic; modulation methods for the purposes of the present disclosure.

A variant on the P-I-N-type M-Z modulator is indicated by Fujita, Levy and Osgood, in US Patent Application 20040047531, incorporated herein by reference. An M-Z branch structure, composed of rib waveguides of MO material, whose two arms are subject to transverse MO effects which act to retard phase. The particular configuration proposed is as an optical isolator, but the method has an novel adaptation for pixel-logic modulation for the present disclosure: the methods of Green et al are transferred to the MO materials regime, with the difference in the fact of the non-reciprocal nature of MO effects (allowing for reflection effects in the arms, thus reducing arm lengths), particularly in the form of photonic-bandgap periodic structures (such as photonic bandgap (PBG) gratings, see Levy US Patent Application 20040080805, incorporated by reference) in the MO MZ arms; and potentially smaller dimension of the field-generating means (as compared to the P-I-N) structure. These differences with the Green EO/P-I-N MZ indicates possibilities for greater miniaturization of the overall device as compared to the Green MZ modulator.

This then introduces another preferred class of modulator, magneto-optic (MO) or magneto-photonic crystal (MPC) modulators, whose operating frequency is generally highly efficient at infrared or near-infrared frequencies, but whose efficiency has generally been shown to drop dramatically as wavelengths transition from visible red to green, and most dramatically of all, the visible blue band.

While improvements have been demonstrated in MO materials and MPC structures, including the first practical MO blue material realized under the direction of the inventor of the present invention, these improved efficiencies are still only a fraction of what may be realized at conventional telecommunications wavelengths. This is due to the typical employment of the ferro-magnetic materials which have exhibited the largest Verdet Constants and thus the largest Faraday rotations, such as iron-garnet thick and thin films. Among the best-performing bulk materials are Bi-substituted YIG (yttrium iron garnet) films. The absorption in the blue band by the iron in these materials accounts for the poor transmission as visible frequencies approach the blue band, with maximum absorption occurring in the visible blue. Among the best performing of these BIG films are the thick films manufactured by Integrated Photonics of New Jersey, USA, which also exhibit very high transmissions and Faraday rotation up to the visible red part of the spectrum.

Among leading types of MO or MPC modulators, with materials chosen for optimal logic and signal-processing operation at infra-red, near infra-red, or visible red), among the most preferred for the purposes of the present disclosure are planar modulators developed by Levy in pending US Patent Application 20040080805. The Levy MO devices are planar photonic bandgap-type gratings structures, including gratings geometries which maintain stable magnetization states (remanence) once saturated by an imposed magnetic field. Highly efficient at telecommunications wavelengths, including low-loss, high speed, low power, bi-stable (via latching/remanence), and a small footprint (approximately 10 μm×10 μm) make the Levy PBG MO devices potentially highly competitive with the Green MZ devices.

Additional preferred types are the periodic thin-film MPC “light baffles” proposed by the present inventor (Light Baffle PCT), which take the form of series of magneto-optic and other dielectric films, of thickness typically lambda/4, interlayered with field-generation elements, preferably in the pixel area itself and transparent to the frequencies of the light transmitted through the pixel. The interlayering of in-pixel field generating structures provides for management of magnetization throughout the thickness of the thin-film stack and between pixels; placing of the field-pulse generating means in the pixel area itself allows for each pixel to be surrounded by index-contrast materials or periodic structures which guide each pixel beam through the stack for effective pixel formation.

Work led by the inventor of the present disclosure demonstrated practical MOSLM's with switching speeds below 15 ns, with materials developed with intrinsic remanence after imposition of an external pulsed magnetic field.

Other MO devices of note include the magneto-optic spatial light modulators (MOSLM) proposed by Inoue et al and commercialized in conjunction with FDK. The most recent example of the Inoue proposals is found in Pending US Application 20040036948, which improvements in the structuring of the SLM, particularly the use of two conducting layers and isolating grooves that do not need to extend completely through the MO film, which reduces the size of field required and simplifies fabrication, compared to earlier proposals by Inoue et al, this application incorporated herein.

A further variant in the field of MO and MPC modulators, encompassed by some embodiments of the present invention, includes the magneto-plasmonic modulator Chau, Irvine and Elazzabit of the University of Alberta, proposed in The IEEE Journal of Quantum Electronics, May 2004. This subtype has the potential for improved feature-size reduction, multi-gigahertz speed, and frequency tunability.

While these examples represent preferred methods of modulation from photonics and opto-electronics generally, the present invention is not limited to these types, and encompasses the use of any modulation method optimized to frequencies, intensities and bandwidths not directly dictated by the requirements of visible image display and projection, since other methods, devices, and operations are employed to efficiently realize the other characteristics of visible image display.

The operative stage following pixel-logic, under the present proposal which decomposes the formation of final pixels into separate operative components and optimized means to perform those operative components “separately,” is wavelength optimization.

Commercially available methods for frequency or wavelength modulation include the employment of periodically-poled lithium niobate for quasi-phase-matching. For preferred embodiments of the overall disclosure, which de-compose the pixel-modulation process into discrete, optimized pixel-logic, color modulation, and intensity modulation, this is a preferred embodiment of the pixel-logic stage, device and operation in a de-composed pixel-modulation scheme.

Highly efficient wavelength shifting of electro-magnetic waves through such engineered materials have been demonstrated and implemented in compact laser-light devices by companies such as Arasor. Efficient RGB light illumination is achieved by wavelength-shifting of input electro-magnetic energy through the periodically-poled medium. Methods are disclosed in Arasor's U.S. Pat. No. 7,436,579, “Mobile charge induced periodic poling and device” incorporated herein by reference Methods of fabrication, with a particular focus on magnesium oxide doped congruent lithium niobate, realize improved grating structures and devices fabricated therefrom. From the disclosure, “Highly efficient domain gratings can be achieved utilizing this device structure, for example an effective nonlinear coefficient of greater than 16 pm/V has been achieved for blue frequency doubling with a grating period of 4.45 um.” Proposals are made in the Arasor patent for projection systems in which the sourcing RGB illumination is provided by the QPM device methods, in conjunction with DMD (digital micro-mirror device) or scan-line generating means such as GLV (grating light valve). In these schemes, frequency conversion or wavelength shifting occurs in bulk illumination before the pixel switching in the array or scan device.

In reflective-type pixel modulation schemes, this is a reasonably effective approach, but it has significant limitations that prevent its application to the signal-processing system of the present disclosure and therefore its potential for realizing, in net, an optimally efficient pixel modulation technology.

At an optical system level, implementation of a free-space reflective solution is non-optimal. Reflection of light from such devices to an intensity-modulation means is impractical, as an entire image or scan-line must be accurately painted on a subsequent device array in free-space to perform the intensity modulation (typically, signal amplification). The issues of dust and alignment, which is a problem found in RPTV (rear-projection TV) systems employing DMD's (including DMD's with laser illumination sources), make the use of a second free-space array for pixel amplification impractical.

In addition, reversal of the order operations, putting the frequency-shifting operation ahead of the pixel-logic operation, eliminates the opportunity for highly-distributed versions of the proposed architecture, which basic pixel-logic states are distributed as optical signal over a network and routed to display fixtures, where signal is frequency shifted and amplified, as needed, by preferably relatively cheap and “dumb” components in a display “fixture.”

Finally, and importantly additionally, DMD is not “best-in-breed” in terms of switching speed and other optimization criteria for pixel-logic operations, and so does not satisfy the purpose of the present disclosure, to realize optimization of each discrete operation that makes up modulation (whether opto-electronic or all-optical). In effect, choosing DMD or similar modulation methods sacrifices speed other switching performance criteria for relatively-broadband switching capability (assuming a mirror material/surface which is reflective for R, G and B bands). If a reflective pixel-logic technology is used, better to fabricate from materials which are nearly perfectly reflective at an optimal frequency/band, and then color-shift afterwards with materials and methods optimized for that purpose. But this of course is an example of the present disclosure, and not of the systems proposed and commercialized by Arasor and others.

Once the pixel-state is set by pixel-logic operations and devices, there are two types of frequency modulation/conversion devices that may be employed as the next stage, one type being relatively passive, and the other relatively active.

For some embodiments of the system and some embodiments of the color-modulation stage, device, and operation:

Relatively-passive frequency modulation devices themselves are of two basic types: 1) un-pumped materials which perform set frequency-shifting, with materials typically chosen and tailored to a particular color band, or 2), as with the Arasor QPM technology, a passive-energized material structure, in which for each subpixel or pixel, for instance, there is an electrode disposed across the structured materials.

Relatively-active frequency modulation devices are also of two basic types: 1) a logic-addressed shifting-device that is only powered if a signal is (passive-matrix or active-matrix) addressed to the device as “on.” Depending on the power requirements of energizing the device, this added complexity may be in net less costly than the second version of the passive types, in which power is always “on.” 2) a pixel-color tunable shifting-device (in contrast to an RGB subpixel-type color systems, and other similar component-color systems), where the magnitude of wavelength shifting is set based on the final color band required.

Power for either passive-energized or actively-addressed-energized frequency modulation devices may either be supplied by an electrical circuit, such as a passive or active matrix, or supplied by the optical power of the pixel or subpixel signal itself.

[ANOTHER PREFERRED EMBODIMENT OF OVERALL DE-COMPOSED SCHEME (may also be separate disclosure) arises from color-modulation of non-visible constant illumination, which (by default, due to the nature of the human visual system) implements pixel-logic, to separate pixel-logic stage/device/operation deleted; and in one sub-variant, an energy recovering stage/device/operation is added.

This second type of tunable color-shifting, combined with a non-visible input frequency, also provides the basis of another variant of the proposed “componentized” display and projection technology of the present disclosure. In this important and novel variant, input illumination is non-visible (higher or lower frequency than the visible range, or both), but constant (or relatively so). A power-coupling circuit is implemented by use of a reflective material or photo-voltaic material that is introduced as a component after the color-shifting stage, which reflects the non-visible frequencies if they are NOT shifted and pass through the color-shifting material.

If a reflective material is employed, such as an optimized photonic bandgap material and structure, such as the “perfect dielectric mirror” commercially available from Omniguide, Inc., a tailored version of such materials is used (employing method well-known to the art of photonic crystals design, modeling and fabrication), to be reflective of only the non-visible bands. In orientation, the reflective mirror may bounce the non-visible light back down the axis of propagation, and thus return to the illumination means (cavity, optics, devices, etc.)

If a photo-voltaic material is employed, it will be composed of materials and/or structures which are transparent to visible wavelengths, but active for the non-visible wavelengths of the source illumination means. Energy is recaptured in this fashion.

Other energy-recapture means may be employed in place of either a photo-voltaic or reflective-recapture scheme.

In this variant of the de-composed pixel modulation system for displays and projectors, the use of a non-visible source illumination eliminates the conventional “on-off” pixel-logic operation, leaving only color-shifting and intensity modulation. Because the human visual system (HVS) cannot see un-shifted non-visible illumination, physically and structurally the “on-off” energizing component has been deleted, but effectively, the color-shifting stage itself, in the context of the HVS, is realizing the pixel-logic operation by default. Tunable and “static” addressed frequency-shifting may be employed for this variant, with the tunable version realizing the more compact type, by discarding multiple sub-pixels/channels in favor of a single tunable final-color pixel.

The energy recapture method is thus an optional additional de-composed stage added to the proposed system, and in fact may be employed as an optional stage for many other variants, including the more typical pixel-logic/frequency conversion/intensity modulation sequence.

If a non-energized color-shifting material and device is partially absorbent of those frequencies, thermal energy may be re-captured from the heated elements at that (or any other stage in which optical energy is lost from the signal and absorbed or scattered by the materials/device) by thermal recovery methods known to the art.

To improve bandwidth of color-conversion, an optional variant includes a signal-splitter after the pixel-logic stage, which transfers the modulated signal to two or more branches where frequency conversion is performed with materials and devices optimized to produce a broader band in a target color range. Post-color conversion, the separate channels are recombined. This may be implemented in chip, bulk component, or fiber-device/photonic textile versions.

A second preferred embodiment of tunable and non-tunable color-modulation stage, device and operation of the overall “de-composed” pixel modulation system, applies a wavelength/frequency shifting method known to the art, specifically proposed by Reed, Soljacic, Joannopoulos et al at MIT, in Pending US Application 20050030613, “Shockwave modulation and control of electro-magnetic radiation” incorporated herein by reference.

According to one aspect of the invention, there is provided a method of modifying or converting frequency of electromagnetic radiation input into a nonlinear medium. The method includes forming a moving grating in the nonlinear medium by introducing at opposite ends of the nonlinear medium a first set of electromagnetic radiation having varying frequencies. Electromagnetic radiation is inputted into the nonlinear medium at a first frequency. Also, the method includes extracting electromagnetic radiation at a second frequency from the nonlinear medium. The moving grating in the nonlinear medium allows for electromagnetic radiation to be modified into the second frequency.

Among the virtues of the proposed method is the ability to change the frequency of electromagnetic radiation over a wide frequency range (typically 20% or more) with high efficiency:

“Analytical theory predicts that there is only one reflected frequency in the limit of a narrow photonic crystal bandgap. This fact enables 100% efficiency in the conversion process. In practice, the small bandgap in the nonlinear material is well into the single reflected frequency regime.”

A shockwave is introduced into a photonic crystal—explosive loading, high-intensity laser, pressure, electric field, temperature—and effects a dielectric modulation of index. Among the preferred means employed are coupled inductor-capacitor resonators. Methods for creating the shock waves include via “MEMS devices, rotating, spiral photonic crystal pattern, etc., controlled by force of light It is estimated that the forces supplied by light are of sufficient magnitude to displace a typical MEMS device on the order of 10% of the wavelength of 1.55 .mu.m light for intensities in the 10 milliwatt range.” Use of amorphous metal springs, in a novel proposal of the present embodiment, for the mechanical (MEMS) spring resonator may be of particular benefit.

Wavelength conversion may be “up” or “down”: a shockwave in the direction of optical wave, up-conversion of frequency; shockwave in reverse, down conversion

In upconversion, when light trapped by shock front, the frequency increases. From non-linear effects of light trapped in localized states, amplitudes several orders of magnitude higher than in pre-shocked state possible. From the disclosure:

While a significant change in the frequency of electromagnetic radiation through mechanical means usually requires the interaction with objects that are moving at a significant fraction of the speed of light, the adiabatic approach does not have this requirement. The adiabatic nature of the evolution of the radiation up in frequency through the total system bandgap has the property that it can be arbitrarily slowly completed with the same large shifts in frequency. This key physical mechanism liberates the shocked photonic crystal from the impossible task of interface propagation near the speed of light. Finally, it should be noted that a time-reversed, frequency lowering effect also occurs in this adiabatic picture.

There exist special places in a photonic crystal near a band edge where the phase of reflected light is a strong function of the velocity of the reflecting surface. These special locations exist in the neighborhood of places where dH/dx=0, where H is the magnetic field. If a reflecting surface, such as a mirror or another photonic crystal, is moved in the vicinity of these locations, an unusually large frequency shift of the reflected light may be observed. The presence of extra frequencies in the reflected signal is a form of modulation.

Adiabatic evolution of light through overlapping bandgap regions: The light is essentially trapped in a cavity which is “squeezed” as the shock compresses the lattice, thereby increasing the frequency. This occurs once each time the shock propagates through a lattice unit.

Another approach in utilizing moving photonic crystals to achieve highly efficient frequency conversion of electromagnetic radiation. This creates a moving periodic modulation or moving grating of the dielectric, or moving photonic crystal 4, within the nonlinear region. The efficiency of this conversion in a phase matched system is 100% for light of bandwidths below the bandgap size of the moving photonic crystal, which can be about 10.sup.−3.omega..sub.0 in practice. This method of frequency conversion can be performed on arbitrarily weak input signals.

Conversion may be pulsed or continuous: the dimensions of lattice constant and shock front thickness, determines pulse or continuous conversion—a much larger shock front, compared to lattice constant, makes conversion continuous.

The bandgap of crystal can determine amount of frequency conversion; moving surface (shock) and reflective fixed surface (photonic crystal mirror, frequency dependent), also tunes bandwidth. Defects in crystal useful, for efficiency of conversion

The discussion concludes with an overall recommendation of their approach over others, with the final, important conclusion:

Hence, some embodiments of the present invention's devices allow the generation of an arbitrary frequency, which is tunable by adjusting the size of a bandgap. Generation of an arbitrary frequency through existing means is difficult and costly. The strong interaction of light and matter through the high pressure modes outlined here provides an alternating to nonlinear material effects which require high intensities and electronics which translate optical signals into mechanical effects. Frequency conversion can be accomplished through some embodiments of the present invention's devices without any supplied power.

Also proposed is a novel all-optical device employing their proposed frequency conversion methods: “a specific example of how a signal can be transferred from one wavelength to another using a thin reflecting film as an intermediary. A signal on the left modulates the displacement of the thin film which modulates the light of a different frequency on the right side.”

In a novel application to the present disclosure, a tunable frequency shift is implemented by the displacement beam, rather than by electronic signal. In the novel system of the present disclosure, the need for multiple sub-pixels is eliminated, because a single pixel is employed, whose color state is selected by means of the displacement beam. The MIT methods allow for bandwidth control in the same system. This realizes an optimized version of the wavelength optimization/color conversion operation, stage and means, and in addition is the preferred method for the preferred embodiment of the present disclosure in which pixel-logic is implemented by default in the de-composing of the color-selection stage and the use of non-visible (recoverable) input illumination that is color selected and brought into the visible range by default at the same time.

An optimal optical pulse-delay feature of the MIT method, implemented by means of controlling the shock velocity, may be employed to realize frame staggering or manipulation of frame rates. This may be implemented by electro-optic or the novel all-optical methods.

In an optional but base-case embodiment, in which at least some pixels in a color-system need intensity amplification—whether because the prior operative stages produced pixel-logic of insufficient intensity compared to other colors, or in general for balancing of intensities, or for higher contrast (such as in Hi-dynamic range imaging, HDRI)—there is a signal amplification operation, stage and means following the color or wavelength optimization stage, operation and means.

In an alternative embodiment, wavelength optimization may follow intensity amplification.

A final preferred embodiment of the present disclosure for frequency conversion employs more conventional absorption-emission materials and methods, including phosphor absorption and methods familiar from LED materials systems.

Whether all subpixels need amplification to the same degree, or some pixels more than others, or some pixels need some amplification while others need none at all, or whether certain regions of an image need general amplification or a gradient of amplification for increased dynamic range, will be determined by issues such as the varying pixel-logic methods and means (which may vary between color subpixel channels), the wavelength optimization (shifting, bandwidth broadening) means (which may also vary between channels), the color system itself (RGM versus other systems, which may include white-light subpixels, etc.), and dynamic range management methods and systems for increasing dynamic range across an image space.

Among the available methods for intensity amplification include those familiar from telecommunications. Optical amplifiers include erbium-doped amplifiers (using the typical gain-medium employed in lasing), including in silicon fibers. The Erbium ions are pumped, raising the energy state of electrons, such that when a signal passes through the medium, electrons drop from the excited state and emit at the signal frequency, increasing the intensity of the signal. Other rare-earth dopants are employed for other frequencies, such as Thulium and Ytterbium, (these are only practical for the present disclosure if intensity amplification occurs prior to wavelength optimization) and dopants appropriate to visible wavelengths are employed.

Semiconductor optical amplifiers (SOA) provide another materials/device platform to implement signal amplification. Vertical cavity SOA's provide a LSI array architecture which is beneficial to the present disclosure in the fabrication of integrated arrays according to various embodiments of the de-composed, step-optimized system.

In the semiconductor regime, Raman Amplification may also be employed, as demonstrated by Intel in its continuous wave silicon laser, Nature, Volume 433, Feb. 17, 2005. The Raman effect in silicon is 10000× stronger than in glass silica. This, among all amplification methods, which may be employed in a vertical cavity SOA-type architecture, is perhaps the most preferred.

In general, the pump means is most commonly optical, and when optical, it is optimally in a non-visible wavelength (an efficient photonic crystal filter for any non-absorbed pump light may be employed in series after the intensity amplification stage to remove an irradiation of that pump wavelength that might exit the viewable pixel area). It may be co-axial with the elements of the present disclosure set in series, or the pumping beam may be inserted at ninety-degrees or at another angle but not co-axial; preferable, it enters at an angle acute to the exit channel, such that the pump beam, if it is continuously “on”, will be deflected in the opposite direction to the final viewable pixel or subpixel.

Intel's P-I-N-based Raman continuous-wave laser as a preferred approach could also thus include non-optical pumping of the silicon.

In addition, according to this system where final illumination levels (per subpixel, per pixel) are tuned after the pixel-logic and/or wavelength optimization stages, operations and means, taken to an extreme case, the initial input illumination means for the image display and projection system may be an extremely low-level illumination stage.

Selective amplification, on a pixel or subpixel level, thus has the potential to reduce power consumption of the overall system substantially. In an “always on” bulk illumination source pumping optical energy into a system at a maximum level, the system is only using a fraction of that source at any one time, leading to greater heat absorption and loss, and impacting operating efficiencies of some thermally-sensitive components. A low-level source illumination, which is “rejected” by the pixel-logic light valve, means less loss and less heat absorption by de-composed operations/stages/components in the de-compose pixel modulation system. Power is selectively added, per sub-pixel or pixel only afterwards, only after the “on” or “off” state of the pixel is set.

Versions of the proposed system, such as the version which employs color-shifting to default implement pixel-logic at the same time, may or may not use low-level input illumination. But optimized versions may potentially be realized by employing low-level source illumination in this state as well, so that the non-visible source illumination that is recovered by the system (as disclosed elsewhere herein) when not shifted is still a low-level initial illumination, which is then intensity amplified after the color-shifting/default pixel-logic stage.

Devices of any size may be realized employing arrays of the de-composed pixel modulation systems encompassed by the present disclosure, including versions with arrays of MZ or MPC modulators, integrated or spatially separated (including by great distances, as proposed in the distributed system of the present disclosure) with arrays of frequency-conversion materials and devices, including preferred shock-wave & photonic crystal frequency conversion and lithium-niobate QPM frequency conversion materials and methods and “static” absorption-emission (e.g., phosphor) materials, and further integrated or spatially separated from arrays of intensity amplification materials and devices, may be implemented. The source and location of pixel-logic and frequency conversion, in particular, may be physically quite distant, or otherwise contained in “image server” architectures that are not flat or compact like flat panels or micro-displays or SLM's such as the Texas Instruments proprietary DMD, DLP, or LCoS SLM's employed in front and rear projection systems.

They may be implemented on chip, on PCB-type structures, integrated in-fiber, and only at the viewable “display fixture” stage integrated via optics structures into one viewable, integrated image display surface. Intensity amplification may be local in a building, in an image display server, with or without the pixel-logic and wavelength optimization stages in the same server structures, or local to the display fixture.

Final display structures may be passive tensioned-membrane intelligent structural systems employing optical fiber in quasi-projection, stretched membranes (see incorporated applications discrete textile-structured displays formed of 3D solid structures with passive or active fibers (see incorporated patent applications); thinfilm flat panel displays, compact SLM's combined with projection optics; or conventional rigid-case, solid substrate display structures.

In general, the “de-composing” of pixel-signal modulation into discrete processing operations opens up many possibilities for leveraging and integrating into the methods and infrastructure of telecommunications and the server-paradigm that is part of it.

While particular embodiments have been disclosed herein, they should not be construed to limit the application and scope of the proposed novel image display and projection, based on de-composing and separately optimizing the operations and stages required for pixel modulation.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. The apparatus substantially as disclosed herein.

2. The method substantially as disclosed herein.
